(19) United States
(12) Patent Application Publication
(10) Pub. No.: US 2025/0216936 A1
(43) Pub. Date: Jul. 3, 2025

(54) HEAD-MOUNTABLE DEVICE FOR USER GUIDANCE

(71) Applicant: Apple Inc., Cupertino, CA (US)

(72) Inventors: Ivan S. MARIC, Palo Alto, CA (US); Grant H. MULLIKEN, Los Gatos, CA (US); Marinus MEURSING, San Jose, CA (US); Mary A. PYC, Campbell, CA (US)

(21) Appl. No.: 18/851,036

(22) PCT Filed: Apr. 3, 2023
(86) PCT No.: PCT/US2023/017334

§ 371 Date: Sep. 25, 2024

Related U.S. Application Data
(60) Provisional application No. 63/327,675, filed on Apr. 5, 2022.

(51) Int. Cl. G06F 3/01; G06F 3/16

(52) U.S. Cl. CPC G06F 3/013; G06F 3/167; G06F 3/012

(57) ABSTRACT

A head-mountable device can facilitate user thought processes by recording user-perceivable experiences during a first mode while the head-mountable device is operated in a capture mode. While in the capture mode, the head-mountable device can record inputs from the user. During a second mode, the head-mountable device can reproduce the previously recorded experiences as well as the user inputs so that the user can resume development of the thoughts and ideas associated with the first mode. The head-mountable device can also track the user's conditions to monitor attention levels of the user and provide indicators to prompt a user to perform activities that will help the user refocus and/or provide additional inputs.

### CROSS-REFERENCE TO RELATED APPLICATION

This application claims the benefit of U.S. Provisional Application No. 63/327,675, entitled “HEAD-MOUNTABLE DEVICE FOR USER GUIDANCE,” filed Apr. 5, 2022, the entirety of which is incorporated herein by reference.

### TECHNICAL FIELD

The present description relates generally to electronic devices, and, more particularly, to electronic devices that guide and direct a user with attention, memory, and cognition.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a top view of a head-mountable device in use by a user, according to some embodiments of the present disclosure.

FIG. 3 illustrates a view of the head-mountable device of FIG. 2 providing a user interface in a capture mode, according to some embodiments of the present disclosure.

FIG. 4 illustrates a flow diagram of an example process for operating a head-mountable device in a capture mode, according to some embodiments of the present disclosure.

FIG. 5 illustrates a top view of the head-mountable device of FIG. 2 in use by a user, according to some embodiments of the present disclosure.

FIG. 6 illustrates a view of the head-mountable device of FIG. 5 providing a user interface in a standard mode, according to some embodiments of the present disclosure.

FIG. 7 illustrates a top view of the head-mountable device of FIGS. 2 and 6 in use by a user, according to some embodiments of the present disclosure.

FIG. 8 illustrates a view of the head-mountable device of FIG. 7 providing a user interface in a playback mode, according to some embodiments of the present disclosure.

FIG. 9 illustrates a flow diagram of an example process for operating a head-mountable device in a playback mode, according to some embodiments of the present disclosure.

FIG. 10 illustrates a view of a head-mountable device providing a user interface, according to some embodiments of the present disclosure.

FIG. 11 illustrates a view of the head-mountable device of FIG. 10 providing a user interface with a first indicator, according to some embodiments of the present disclosure.

FIG. 12 illustrates a view of a head-mountable device of FIGS. 10 and 11 providing a user interface with a second indicator, according to some embodiments of the present disclosure.

FIG. 13 illustrates a flow diagram of an example process for operating a head-mountable device for enhancing user attention, according to some embodiments of the present disclosure.

FIG. 14 conceptually illustrates a head-mountable device with which aspects of the subject technology may be implemented in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

Various electronic devices can be used to capture, create, and edit media, for example, by capturing images, recording audio, storing text, and other such media formats. Electronic devices have become increasingly portable in recent years, offering more opportunities for a user to create media while experiencing everyday life. In this regard, media can be any content that is generated by a user as records, inputs, and/or other data capable of being recorded by an electronic device, such as a head-mountable device. In many cases, media from a user can be based on and/or inspired by interactions with and/or observations of the external environment and/or outputs from an electronic device. As such, the user may create content under circumstances that are detectable, recordable, and reproducible.

In some instances, a user may be interrupted and/or otherwise desire to resume a thought process from an earlier time. However, the circumstances may have changed since that time. Inasmuch as the user's thoughts were mentally connected to the circumstances of that earlier thought process, it can be difficult for the user to resume such thoughts. It can be desirable to provide outputs to a user that will refresh the user's recollection and aid the user further develop thoughts and ideas from a prior mode. It can be further desirable to provide outputs that will respond to a user's attention state and help the user focus and/or perform activities the regain focus.

A head-mountable device can facilitate user thought processes by recording user-perceivable experiences during a first mode while the head-mountable device is operated in a capture mode. While in the capture mode, the head-mountable device can record inputs from the user. During a second mode, the head-mountable device can reproduce the previously recorded experiences as well as the user inputs so that the user can resume development of the thoughts and ideas associated with the first mode. The head-mountable device can also track the user's conditions to monitor attention levels of the user and provide indicators to prompt a user to perform activities that will help the user refocus.

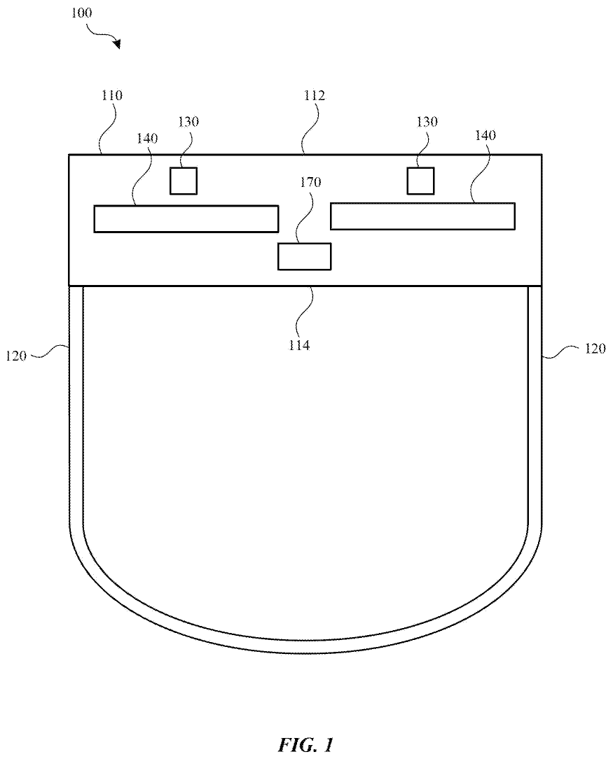

These and other embodiments are discussed below with reference to FIGS. 1-14. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 that is worn on a head of a user. The frame 110 can be positioned in front of the eyes of a user to provide information within a field of view of the user. The frame 110 can provide nose pads or another feature to rest on a user's nose. The frame 110 can be supported on a user's head with the head engager 120. The head engager 120 can wrap or extend along opposing sides of a user's head. The head engager 120 can include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. Any number of components can be included within and/or on the frame 110 and/or the head engager 120.

The frame 110 can include and/or support one or more cameras 130. The cameras 130 can be positioned on or near an outer side 112 of the frame 110 to capture images of views external to the head-mountable device 100. As used herein, an outer side 112 of a portion of a head-mountable device is a side that faces away from the user and/or towards an external environment. The captured images can be used for display to the user or stored for any other purpose.

It will be understood that the camera 130 can be one of a variety of input devices provided by the head-mountable device. Such input devices can include, for example, depth sensors, optical sensors, microphones, user input devices, user sensors, and the like.

By further example, a user sensor 170 can perform facial feature detection, facial movement detection, facial recognition, eye tracking, user mood detection, user emotion detection, voice detection, etc. Such eye tracking may be used to determine the direction of a user's attention. By further example, the user sensor 170 can be a bio-sensor for tracking biometric characteristics, such as health and activity metrics. The user sensor can include a bio-sensor that is configured to measure biometrics such as heart rate, electrocardiogra (ECG) characteristics, galvanic skin resistance, and other properties of the user's body. Additionally or alternatively, a bio-sensor can be configured to measure body temperature, exposure to UV radiation, and other health-related information.

The head-mountable device can be provided with one or more displays 140 that provide visual output for viewing by a user wearing the head-mountable device. As shown in FIG. 1, one or more optical assemblies containing displays 140 can be positioned on an inner side 114 of the frame 110. As used herein, an inner side of a portion of a head-mountable device is a side that faces toward the user and/or away from the external environment. For example, a pair of optical assemblies can be provided, where each optical assembly is movably positioned to be within the field of view of each of a user's two eyes. Each optical assembly can be adjusted to align with a corresponding eye of the user. Movement of each of the optical assemblies can match movement of a corresponding camera 130. Accordingly, the optical assembly is able to accurately reproduce, simulate, or augment a view based on a view captured by the camera 130 with an alignment that corresponds to the view that the user would have naturally without the head-mountable device 100.

A display 140 can transmit light from a physical environment (e.g., as captured by a camera) for viewing by the user. Such a display can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

It will be understood that the display 140 can be one of a variety of output devices provided by the head-mountable device. Such output devices can include, for example, speakers, haptic feedback devices, and the like.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld processors with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Referring now to FIGS. 2-4, the user can operate the head-mountable device during a mode in which information is captured (e.g., capture mode). FIG. 2 illustrates a top view of a head-mountable device in use by a user, according to some embodiments of the present disclosure. As shown in FIG. 2, the head-mountable device 100 can include one or more sensors, such as a camera 130, for detecting features of an environment that are perceivable by a user 10, such as objects 90 within a field of view 200 of the camera 130. By further example, the sensors can include a microphone for detecting sounds 96 from the environment and/or from the user. The head-mountable device 100 can further include one or more output devices, such as a display 140, for outputting information to the user 10. Such outputs can be based on the detections of the sensors (e.g., camera 130) and/or other content generated by the head-mountable device. The head-mountable device 100 can include one or more input devices, for receiving input from the user. The input device can be operated by a user to input content while the user is perceiving outputs from the head-mountable device and/or the environment. For example, the input device can include or be operated by a touchscreen, keyboard, mouse, stylus, or other input device. By further example, the input device can be or include a microphone or other voice recognition elements for detecting speech from a user. By further example, the input device can be or include selectable elements (e.g., from a menu) or another input format (e.g., text, handwriting, and the like). By further example, the input device can be a separate device (e.g., smartphone, tablet computer, laptop, smartwatch, wearable device, stylus, and the like) that is communicatively connected to the head-mountable device.

The input can be received by the head-mountable device during active operation of an application of the head-mountable device. For example, the user can provide content to the head-mountable device that is recorded based on operation of an application thereof. By further example, such applications can include a notepad application, a sketchpad application, a word processor application, a presentation application, a spreadsheet application, a drawing application, a 3D drawing application, a 3D clay sculpting application, and the like.

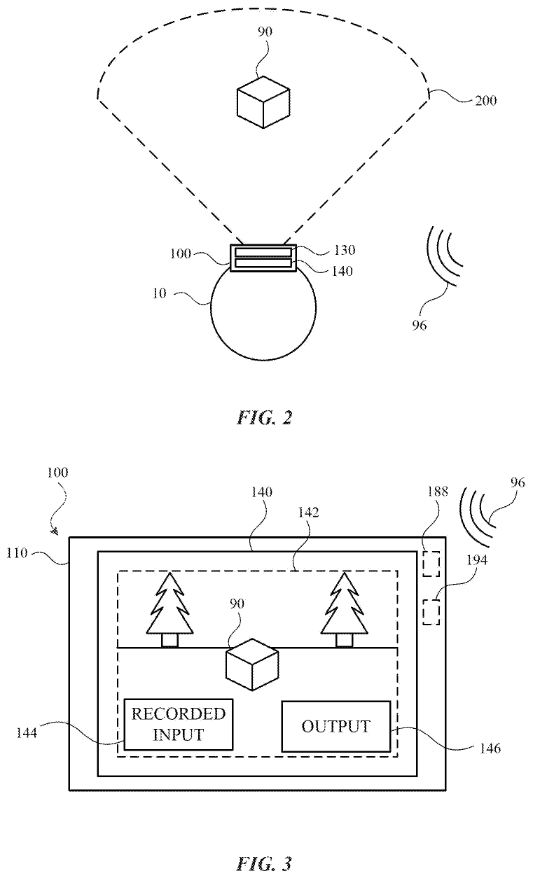

FIG. 3 illustrates a view of the head-mountable device of FIG. 2 providing a user interface in a capture mode, according to some embodiments of the present disclosure. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided. The application can provide one or more features of a user interface for interaction with the user as well as a format for recording the inputs provided by the user.

As shown in FIG. 3, the display 140 can provide a user interface 142 that outputs the view captured by a camera, for example including an object 90 within a field of view of the camera. The microphone 188 can detect sounds 96 from the environment and/or from the user, thereby operating as an environment sensor, a user sensor, and/or an input device. It will be understood that other features of the head-mountable device 100 can also be operated as an environment sensor, a user sensor, and/or an input device.

As the input devices of the head-mountable device 100 receive input from a user, such inputs can be output by the head-mountable device 100. For example, an output 144 can include a representation of the input received and/or recorded from the user. Such an output 144 can allow the user to review, track, and/or monitor the user's own input as received by the head-mountable device 100. As such, the head-mountable device 100 can facilitate receiving and recording the user's inputs provided thereto and allow the user to make a record of thoughts and ideas generated during a first session (e.g., capture session) while the head-mountable device 100 is in a first mode (e.g., capture mode).

The user interface 142 can further include any content generated by the head-mountable device 100 as output 146, such as notifications, messages, text, images, display features, websites, app features, and the like. It will be understood that such content can be displayed visually and/or otherwise output as sound, and the like. Such content may be part of the capture mode or simply output based on other operations of the head-mountable device 100.

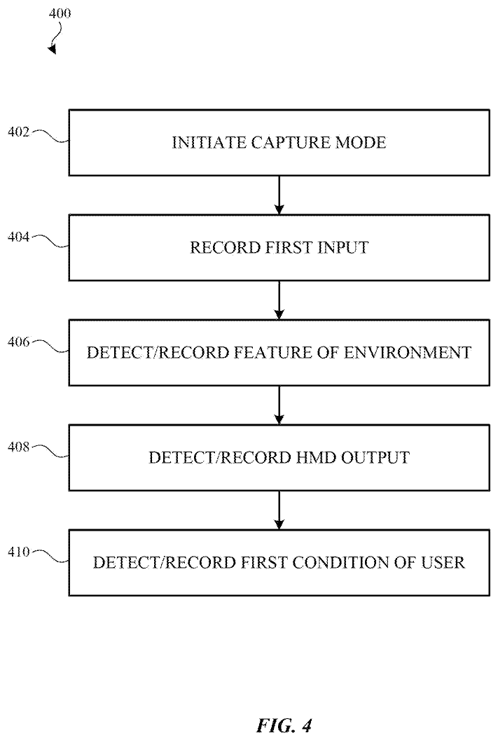

FIG. 4 illustrates a flow diagram of an example process for operating a head-mountable device in a capture mode, according to some embodiments of the present disclosure. For explanatory purposes, the process 400 is primarily described herein with reference to the head-mountable device 100 of FIGS. 2 and 3. However, the process 400 is not limited to the head-mountable device 100 of FIGS. 2 and 3, and one or more blocks (or operations) of the process 400 may be performed by one or more other components or chips of the head-mountable device 100 and/or another device. The head-mountable device 100 also is presented as an exemplary device and the operations described herein may be performed by any suitable device. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

In operation 402, the head-mountable device can initiate a capture mode. Such a mode can be initiated in response to an input received from the user. For example, the user may initiate recordation of inputs (e.g., first input) from the user to the head-mountable device.

In operation 404, the head-mountable device receives and/or records the input from a user. Such input can be received by an input device, as described wherein. Optionally, the input can be also be output to the user for review.

In operation 406, the head-mountable device detects and/or records one or more features of an environment while the head-mountable device receives the user input. For example, an environment sensor can capture visual, auditory, and/or other features of an environment. Such features can be perceivable by the user, either directly or via the operations of the head-mountable device.

In operation 408, the head-mountable device detects and/or records one or more features of an output of the head-mountable device that are provided while the head-mountable device receives the user input. For example, the visual, auditory, and/or other output of the head-mountable device that are perceivable by the user can be recorded for later playback to recreate the experiences of the user.

In operation 410, the head-mountable device detects and/or records one or more conditions of the user exhibited while the head-mountable device receives the user input. For example, the user's heart rate, facial features (e.g., shape based on expressions), eye gaze, pupil dilation, and/or other health metrics can be monitored and/or recorded. Such information can be recorded for later usage to evaluate the effect and/or effectiveness of playback on the user as the head-mountable device, in a playback mode, recreates a user experience from the capture mode.

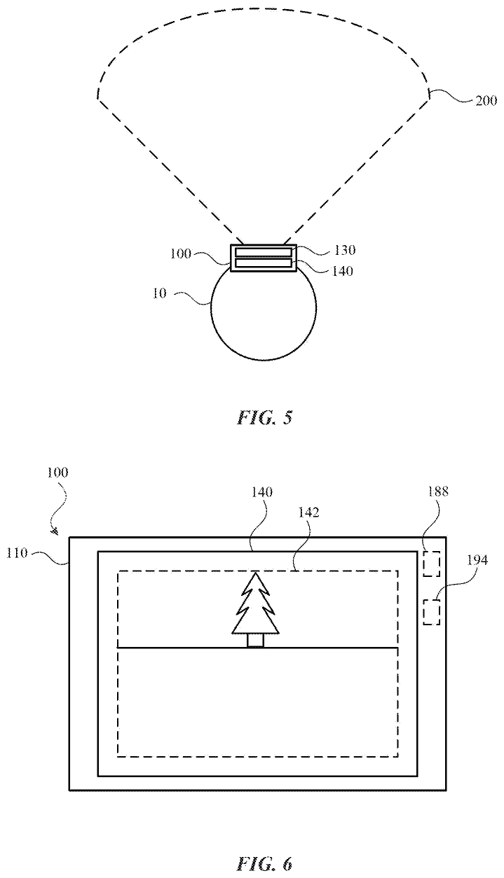

Referring now to FIGS. 5 and 6, a later mode can be one that follows the capture mode. FIG. 5 illustrates a top view of the head-mountable device of FIG. 2 in use by a user, according to some embodiments of the present disclosure. FIG. 6 illustrates a view of the head-mountable device of FIG. 5 providing a user interface in a standard mode, according to some embodiments of the present disclosure. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided. It will be understood that the user interface can differ from other user interfaces based on the selection of environment by the user.

As shown in FIGS. 5 and 6, at a later time (e.g., following the capture mode), the user may be in a different environment and/or performing a different activity. It will be understood that such a change in environment may be by the user's choice and actions and/or otherwise imposed on the user. Nonetheless, the user may desire to resume a thought process from the earlier capture mode, in which the head-mountable device was being operated in a capture mode.

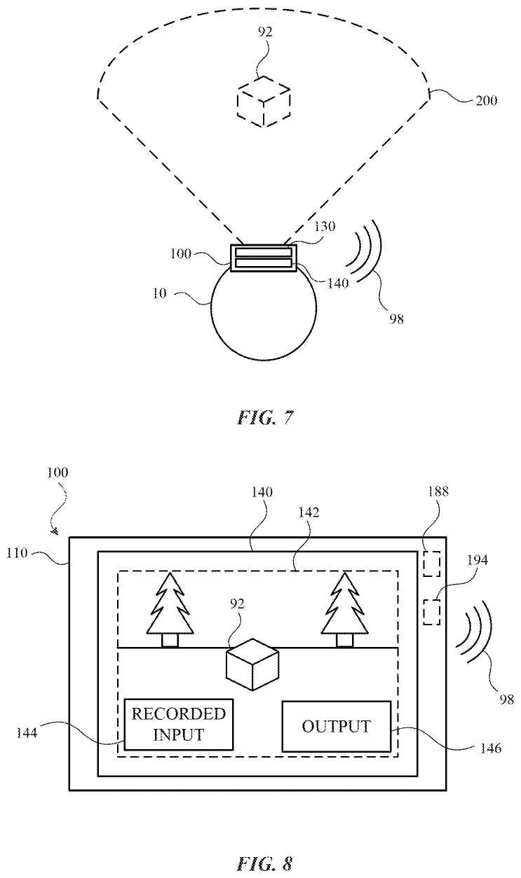

Referring now to FIGS. 7-9, another mode can be one in which content from a capture mode is provided to the user during a playback mode. FIG. 7 illustrates a top view of the head-mountable device of FIGS. 2 and 6 in use by a user, according to some embodiments of the present disclosure. In this operation, the user can be provided with outputs that represent features captured during the capture mode (e.g., while the head-mountable device 100 was operated in the capture mode of FIGS. 2-4). Objects 92 displayed by the head-mountable device 100 in the playback mode can be virtual representations of objects 90 detected in the capture mode. As used herein, “objects” can include discrete objects, persons, scenery, and the like. Where the object 92 is produced, it can be provided as a replica of the object 90. This can include a direct reproduction as captured by the camera or other sensors and/or as an item that is based on the detection of the object 90. For example, the object 92 can be a stylized rendering of the object 90 based on an identification thereof. Where the object 90 represents a person, the object 92 can be output as a representation of the person or characteristics thereof, such as a name, identity, or other personal information. As such, the object 92 can be a representation that brings to mind a memory of the object to the user's mind without necessarily being a full recreation of the object. Sounds 98 output by the head-mountable device 100 in the playback mode can be previously recorded sounds 96 detected in the capture mode. Other outputs can likewise be representations of environment features from the capture mode. By further example, other outputs of the head-mountable device 100 in the playback mode can be recreated outputs that were previously provided during the capture mode.

FIG. 8 illustrates a view of the head-mountable device of FIG. 7 providing a user interface in a playback mode, according to some embodiments of the present disclosure. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

By providing, during the playback mode, the outputs previously recorded from the capture mode, the user can be reminded of the user's own mental state during the capture mode. As such, the user may associate such outputs with the outputs from the capture mode and thereby be more able to continue the thoughts and ideas that started in the capture mode.

As shown in FIG. 8, the user interface 142 can include a reproduction of the recorded output 144 from the capture mode. This can aid the user to recall the content previously provided by the user to the head-mountable device 100. The user can then add to such content by providing further inputs. Such inputs can represent the user's thoughts and ideas during the playback mode, which can in turn be a continuation or extension of the thoughts and ideas from the capture mode. As the input devices of the head-mountable device 100 receive additional input from a user, such inputs can be output by the head-mountable device 100 and add to and/or included with the output 144.

The user interface 142 can further include the output 146 that was generated by the head-mountable device 100 during the capture mode. The content of the output 146 can be output in the same manner as during the capture mode. It will be understood that such content can be displayed visually and/or otherwise output as sound, and the like.

It will be understood that the output of the playback mode can include one, some, or all of the features detected in a capture mode. For example, the head-mountable device 100 can output those features that correspond to the user's attention (e.g., based on eye tracking by an eye sensor) during the capture mode. By further example, the output features can include other features that may not correspond to the user's direct attention during the capture mode, such as features in the peripheral vison of the user. Accordingly, different depths of immersion can be provided during playback mode (e.g., one, some, or all of the features detected during capture mode). The depth of immersion can be based on a detection by the head-mountable device regarding how the user is responding during the playback mode relative to how the user responded to during the capture mode, as described further herein.

The additional input can be received by the head-mountable device during active operation of an application of the head-mountable device. In some embodiments, the head-mountable device can launch an application that was active during the capture mode. For example, the user can be prompted to provide additional content to the head-mountable device that is recorded based on further operation of the same or a different application. As described herein, such applications can include a notepad application, a sketchpad application, a word processor application, a presentation application, a spreadsheet application, a drawing application, a 3D drawing application, a 3D clay sculpting application, and the like.

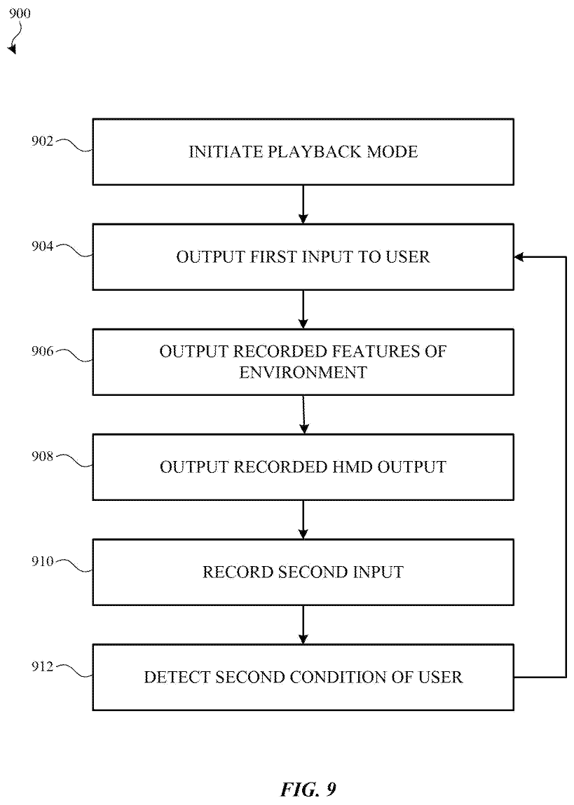

FIG. 9 illustrates a flow diagram of an example process for operating a head-mountable device in a playback mode, according to some embodiments of the present disclosure. For explanatory purposes, the process 900 is primarily described herein with reference to the head-mountable device 100 of FIGS. 7 and 8. However, the process 900 is not limited to the head-mountable device 100 of FIGS. 7 and 8, and one or more blocks (or operations) of the process 900 may be performed by one or more other components or chips of the head-mountable device 100 and/or another device. The head-mountable device 100 also is presented as an exemplary device and the operations described herein may be performed by any suitable device. Further for explanatory purposes, the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

In operation 902, the head-mountable device can initiate a playback mode. Such a mode can be initiated in response to an additional input received from the user. For example, the user may initiate recordation of additional inputs (e.g., second or third inputs, etc.) from the user to the head-mountable device.

In operation 904, the head-mountable device outputs the input (e.g., first input) previously received from the user during the capture mode. Such output can allow the user to recall the previous input and know where and how to continue such inputs.

In operation 906, the head-mountable device can output one or more features of an environment recorded during the capture mode. For example, an output device can output features detected by an environment sensor, such as visual, auditory, and/or other features of an environment.

In operation 908, the head-mountable device can output one or more features of an output that was previously provided during the capture mode. It will be understood that such features need not be detected outside the operation of the head-mountable device, but may nonetheless be perceivable by the user to form, optionally with the features of the environment, an overall experience of the user during the capture mode. As such, by providing them during the playback mode, the user is provided with an experience that resembles the experience during the capture mode.

In operation 910, the head-mountable device receives and/or records additional input (e.g., second or third input) from a user. Such additional input can be received by an input device, as described wherein. Optionally, the additional input can also be output to the user for review. For example, the additional input can be added to and/or provided as a replacement for the first input provided as recorded output 144 in FIG. 8. As such, the additional input received during the playback mode can be represented as a continuation, extension, or replacement of the original input received during the capture mode.

In operation 912, the head-mountable device detects and/or records one or more additional conditions (e.g., second condition) of the user exhibited during the playback mode. It will be understood that the additional condition can be the same type of condition detected during the capture mode (e.g., heart rate, facial features, eye gaze, pupil dilation, and/or other health metrics). The additional condition can be compared to the initial condition to determine whether the user is responding to the outputs of the playback mode in a manner that resembles the user's response to the experience during the capture mode. For example, where one or more conditions satisfied (e.g., above or below) a threshold during the capture mode, the additional condition can be compared to such a threshold (and/or the initial condition itself acting as a threshold) to determine whether the outputs of the playback mode are inducing the same or similar reaction in the user.

Such a comparison can be used to modify the outputs of the head-mountable device. For example, where the second condition differs from the first condition, the outputs can be modified until the second condition of the playback mode matches the first condition of the capture mode. Such modifications can include presenting fewer or more of the features captured during the capture mode. For example, different levels of immersion can be provided by outputting a different number of the previously captured features and/or omitting features that are not part of the previously recorded capture mode. As such, the previously recorded features can be used to evaluate the effect and/or effectiveness of playback on the user as the head-mountable device, in a playback mode, recreates a user experience from the capture mode.

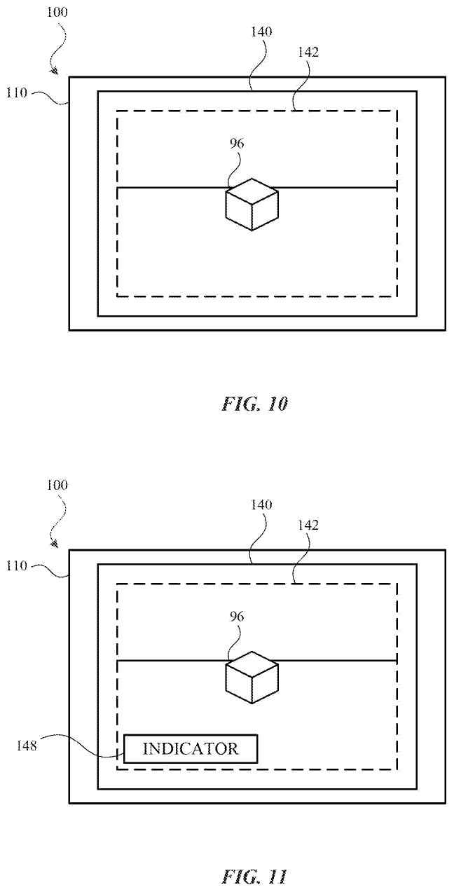

FIGS. 10-12 illustrate view of a head-mountable device providing user interfaces, according to some embodiments of the present disclosure. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

FIG. 10 illustrates a view of a head-mountable device providing a user interface in an initial mode of operation. In such a mode, content can be provide to the user, such as an object 92. The object 92 can represent physical objects in a physical environment and/or virtual objects is a CGR environment. The user's attention on such an object and/or other outputs from the head-mountable device 100 can be evaluated. Such an evaluation can aid the user to achieve a state in which the user comfortably focuses attention on the desired targets without experiencing undue fatigue.

As used herein, an attention level of the user can be detected based on external conditions of the user. One or more of such conditions can be detected by the head-mountable device to determine whether interventions would be beneficial to the user. An attention level can represent a mental state of the user, including mental alertness and mental fatigue. While the user's mental state itself can involve a variety of factors, the attention level of a user can be indicated to the head-mountable device by measurable and objective metrics, as described further herein. As such, the head-mountable device can determine an attention level and react accordingly.

For example, an eye sensor can track features of the user wearing the head-mountable device 100, including conditions of the user's eye (e.g., focal distance, pupil size, etc.). For example, an eye sensor can optically capture a view of an eye (e.g., pupil) and determine a direction of a gaze of the user. Such eye tracking may be used to determine a location and/or direction of interest with respect to the display 140 and/or elements presented thereon. User interface elements can be provided on the display 140. The detections made by the eye-tracking sensor can determine where the user is devoting attention. The user's vision and/or gaze can be monitored to detect an attention level and/or changes thereof. Where a user has focused on a target object for a duration or proportion of time, the head-mountable device can determine that such activity from the user indicates a low attention level. By further example, if a user reads the same passage of text multiple times (e.g., as demonstrated by eye gaze), the head-mountable device can determine that the user is showing insufficient attention levels.

For example, the head-mountable device can include sensors to detect other conditions of the eye, such as pupil dilation, eyelid state (e.g., closure, openness, droopiness, etc.), blink rate, and the like. Such eye conditions can be compared to corresponding target thresholds to determine a user's attention level.

The head-mountable device can further measure health conditions of the user. For example, the head-mountable device can include sensors to detect heart rate, blood oxygenation, blood-sugar level, posture, temperature, complexion (e.g., color), and the like. Such health conditions can be compared to corresponding target thresholds to determine a user's attention level.

The head-mountable device can further measure expressive conditions of the user. For example, the head-mountable device can include sensors to perform facial feature detection, facial movement detection, facial recognition, user mood detection, user emotion detection, voice detection, and the like. Such expressive conditions can be compared to corresponding target thresholds to determine a user's attention level.

FIG. 11 illustrates a view of the head-mountable device of FIG. 10 providing a user interface with a first indicator. As shown in FIG. 11, when the user's attention level is below a target threshold, an indicator 148 can be provided to prompt the user to perform certain actions. Such actions can be designed to raise the user's attention and/or provide relief to allow the user greater ease of paying attention during further operations. The indicator 148 can be an instruction, a notification, an output of a detected condition, and the like. For example, the indicator can indicate an activity that, when performed by the user, allows the user to be more alert. Such an activity may include temporarily ceasing usage of the head-mountable device 100 and/or one or more operations thereof. The indicator 148 can be an element that, when received by the user, allows the user to raise an attention level. For example, the indicator 148 can include a stimulus that engages the user's attention. As shown in FIG. 11, the indicator 148 can be provided in combination with other features of the user interface 142.

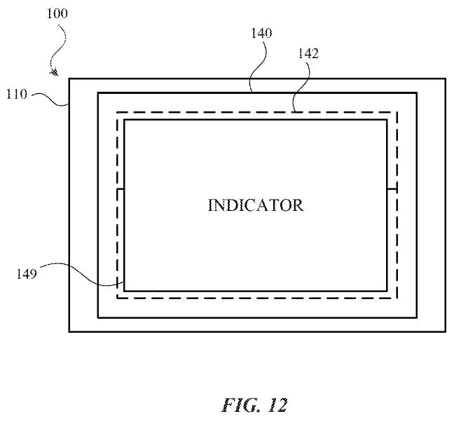

FIG. 12 illustrates a view of a head-mountable device of FIGS. 10 and 11 providing a user interface with a second indicator. As shown in FIG. 12, if the user does not perform an activity or otherwise increase the attention level, a second indicator 149 can be provided. The second indicator 149 can be more engaging to the user and/or limit the user's operation and/or observation of other features of the user interface 142. For example, if the user does not perform an activity, does increase an attention level, and/or allows an attention level to fall below a second threshold, then the second indicator 149 can be applied. Such a second indicator can occupy more of the user interface 142 and/or limit a greater number and/or extent of user interface features. The second indicator 149 can supplement and/or replace the first indicator and/or other features of the user interface 142. The first indicator 148 and/or the second indicator 149 can remain until the user ameliorates the attention level.

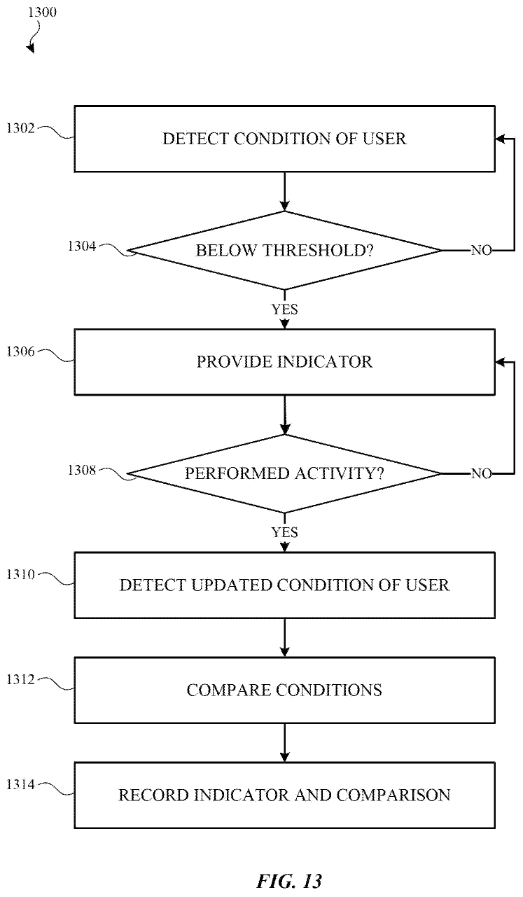

FIG. 13 illustrates a flow diagram of an example process for operating a head-mountable device for enhancing user attention, according to some embodiments of the present disclosure. For explanatory purposes, the process 1300 is primarily described herein with reference to the head-mountable device 100 of FIGS. 9-11. However, the process 1300 is not limited to the head-mountable device 100 of FIGS. 9-11, and one or more blocks (or operations) of the process 1300 may be performed by one or more other components or chips of the head-mountable device 100 and/or another device. The head-mountable device 100 also is presented as an exemplary device and the operations described herein may be performed by any suitable device. Further for explanatory purposes, the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

In operation 1302, a condition of the user is detect, as described herein. The condition represents an attention level of the user. Such a condition can be detected by one or more sensors of the head-mountable device and/or another device.

In operation 1304, the condition is compared to a threshold that represents a target attention level of the user. If the condition is above or at a threshold, then the detection can continue. If the condition is below a threshold, then the attention of the user is determined to be at an insufficient level.

In operation 1306, one or more indicators can be provided to the user. Such indicators can be based on the conditions, thresholds, and the like as described herein. The indicators can be progressively changing based on the detected conditions.

In operation 1308, if the user has not performed a recommended activity or otherwise remedied the attention level, then the indicator can remain or change until such conditions are addressed and/or ameliorated.

If the user has performed a recommended activity or otherwise remedied the attention level, then the head-mountable device can proceed to evaluate the effectiveness of the activity or the indicator. For example, in operation 1310, the head-mountable device can detect an updated condition of the user. Such a condition can be the same type of condition detected in operation 1302.

In operation 1312, the conditions can be compared to each other to determine how effective the indicator, the activity, and/or other events were at improving the attention level of the user.

In operation 1314, the indicator, activity, and/or other event can be recorded along with the comparison as a record of how effectively they improved the user's attention. Such a record can be used and referenced in later operations to determine how the head-mountable device will react to future changes in attention level. For example, where an indicator, activity, and/or other event are found to be highly effective (e.g., bring about a great change in attention level), such an indicator, activity, and/or other events can be used as needed when the user's attention level again is below a threshold. By further example, where an indicator, activity, and/or other event are found to be ineffective (e.g., bring about a small or no change in attention level), such an indicator, activity, and/or other event can be avoided or placed in lower priority when the user's attention level again is below a threshold. As such, the head-mountable device can, over time, become tuned to a user's attention level needs.

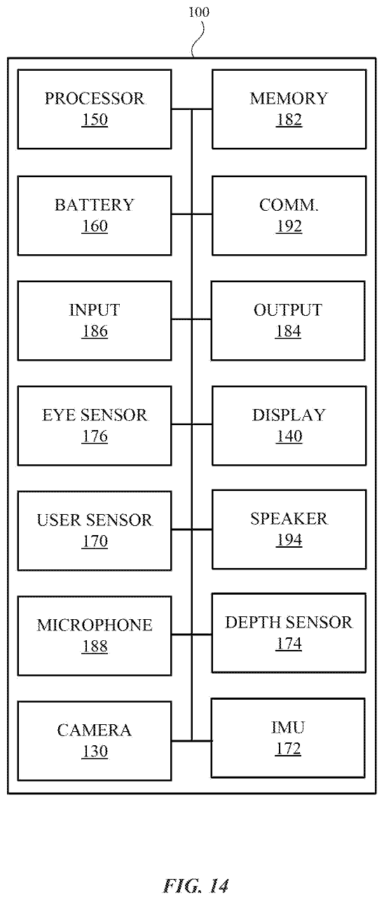

Referring now to FIG. 14, components of the head-mountable device can be operably connected to provide the performance described herein. FIG. 14 shows a simplified block diagram of an illustrative head-mountable device 100 in accordance with one embodiment of the invention. It will be appreciated that components described herein can be provided on one, some, or all of a housing, a securement element, and/or a crown assembly. It will be understood that additional components, different components, or fewer components than those illustrated may be utilized within the scope of the subject disclosure.

As shown in FIG. 14, the head-mountable device 100 can include a processor 150 (e.g., control circuitry) with one or more processing units that include or are configured to access a memory 182 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a processor, a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can include a battery 160, which can charge and/or power components of the head-mountable device 100. The battery 160 can also charge and/or power components connected to the head-mountable device 100.

The head-mountable device 100 can include the microphone 188 as described herein. The microphone 188 can be operably connected to the processor 150 for detection of sound levels and communication of detections for further processing, as described further herein.

The head-mountable device 100 can include the speakers 194 as described herein. The speakers 194 can be operably connected to the processor 150 for control of speaker output, including sound levels, as described further herein.

The head-mountable device 100 can include an input device 186, which can include any suitable component for receiving input from a user, including buttons, keys, body sensors, gesture detection devices, microphones, and the like. It will be understood that the input device 186 can be, include, or be connected to another device, such as a keyboard, mouse, stylus, and the like.

The head-mountable device 100 can include one or more other output devices 184, such as displays, speakers, haptic feedback devices, and the like.

The eye-tracking sensor 176 can track features of the user wearing the head-mountable device 100, including conditions of the user's eye (e.g., focal distance, pupil size, etc.). For example, an eye sensor can optically capture a view of an eye (e.g., pupil) and determine a direction of a gaze of the user. Such eye tracking may be used to determine a location and/or direction of interest with respect to the display 140 and/or elements presented thereon. User interface elements can then be provided on the display 140 based on this information, for example in a region along the direction of the user's gaze or a region other than the current gaze direction, as described further herein. The detections made by the eye-tracking sensor 176 can determine user actions that are interpreted as user inputs. Such user inputs can be used alone or in combination with other user inputs to perform certain actions. By further example, such sensors can perform facial feature detection, facial movement detection, facial recognition, user mood detection, user emotion detection, voice detection, and the like.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics.

The head-mountable device 100 can include an initial measurement unit 172 (“IMU”) that provides information regarding a characteristic of the head-mounted device, such as inertial angles thereof. For example, the IMU can include a six-degrees of freedom IMU that calculates the head-mounted device's position, velocity, and/or acceleration based on six degrees of freedom (x, y, z, 0x, Oy, and Oz). The IMU can include one or more of an accelerometer, a gyroscope, and/or a magnetometer. Additionally or alternatively, the head-mounted device can detect motion characteristics of the head-mounted device with one or more other motion sensors, such as an accelerometer, a gyroscope, a global positioning sensor, a tilt sensor, and so on for detecting movement and acceleration of the head-mounted device.

The head-mountable device 100 can include image sensors, depth sensors 174, thermal (e.g., infrared) sensors, and the like. By further example, a depth sensor can be configured to measure a distance (e.g., range) to an object (e.g., region of the user's face) via stereo triangulation, structured light, time-of-flight, interferometry, and the like. Additionally or alternatively, a face sensor and/or the device can capture and/or process an image based on one or more of hue space, brightness, color space, luminosity, and the like.

The head-mountable device 100 can include a communication interface 192 for communicating with one or more servers or other devices using any suitable communications protocol. For example, communication interface 192 can support Wi-Fi (e.g., a 802.11 protocol), Ethernet, Bluetooth, high frequency systems (e.g., 1400 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communication interface 192 can also include an antenna for transmitting and receiving electromagnetic signals.

Accordingly, embodiments of the present disclosure provide a head-mountable device that can facilitate user thought processes by recording user-perceivable experiences during a first mode while the head-mountable device is operated in a capture mode. While in the capture mode, the head-mountable device can record inputs from the user. During a second mode, the head-mountable device can reproduce the previously recorded experiences as well as the user inputs so that the user can resume development of the thoughts and ideas associated with the first mode. The head-mountable device can also track the user's conditions to monitor attention levels of the user and provide indicators to prompt a user to perform activities that will help the user refocus.

Various examples of aspects of the disclosure are described below as clauses for convenience. These are provided as examples, and do not limit the subject technology.

Clause A: a head-mountable device comprising: an input device configured to receive a first input, a second input, and a third input from a user; an environment sensor configured to detect a feature of an environment; an output device; and a processor configured to operate the head-mountable device in a first mode in which: the input device receives the first input; and the environment sensor detects the feature of the environment while the input device receives the first input; the processor being further configured to operate the head-mountable device in a second mode in which: the input device receives the second input; the output device outputs to the user the first input and the feature of the environment from the first mode; the input device receives a third input from the user while the first input and the feature of the environment are being output; and record the third input to be stored with the first input.

Clause B: a head-mountable device comprising: an input device configured to receive a first input, a second input, and a third input from a user; a user sensor configured to detect a first condition and a second condition of the user; an output device; and a processor configured to operate the head-mountable device in a first mode in which: the input device receives a first input from the user; the processor records a feature of an event that is perceptible to the user while the input device receives the first input; and the user sensor detects a first condition of the user while the input device receives the first input; the processor being further configured to operate the head-mountable device in a second mode in which: the input device receives a second input from the user; the output device outputs the first input to the user; the user sensor tracks a second condition of the user while the input device receives the first input; and the output device outputs the feature of the event to the user based on a comparison between the first condition and the second condition.

Clause C: a head-mountable device comprising: an output device; a user sensor; and a processor configured to: operate the user sensor to detect a condition of a user wearing the head-mountable device, the condition indicating an attention level of the user with respect to an output of the output device; and when the condition of the user is below a threshold, operate the output device to provide an indicator to perform an activity until the condition exceeds the threshold.

One or more of the above clauses can include one or more of the features described below. It is noted that any of the following clauses may be combined in any combination with each other, and placed into a respective independent clause, e.g., clause A, B, or C.

Clause 1: the input device comprises at least one of a microphone, a touch input device, or an eye tracking device.

Clause 2: the output device comprises at least one of a speaker or a display.

Clause 3: the environment sensor is a camera; the output device is a display; and the processor is configured to: detect the feature of the environment by capturing an image of the environment with the camera; and output the feature of the environment by outputting the image with the display.

Clause 4: the input device is a microphone; the output device is a display; the first input is speech from the user; and the processor is configured to output the first input on the display as text corresponding to the speech.

Clause 5: an eye sensor configured to detect a condition of an eye of the user, wherein the feature of the environment is detected by the environment sensor and output by the output device based on a detection of the eye sensor.

Clause 6: the feature of the event that is perceptible to the user comprises a feature from an environment.

Clause 7: the feature of the event that is perceptible to the user comprises an output from the output device.

Clause 8: in the second mode, the feature of the event to the user is output until the second condition of the user matches the first condition of the user.

Clause 9: the user sensor is an eye tracking sensor, and the first condition and the second condition of the user are conditions of an eye of the user.

Clause 10: the user sensor is an eye sensor, and the condition comprises at least one of pupil dilation, eyelid status, or blink rate.

Clause 11: the user sensor comprises at least one of a depth sensor or a camera, and the condition comprises a feature of a face of the user.

Clause 12: the condition comprises at least one of heart rate, respiration rate, or temperature.

Clause 13: the output device comprises a display, and the indicator comprises a visual feature output by the display when the condition is below the threshold.

Clause 14: the threshold is a first threshold; the visual feature is a first visual feature; the indicator comprises a second visual feature, different than the first visual feature, output by the display when the condition is below a second threshold, different than the first threshold.

Clause 15: the display is configured to output an initial visual feature when the condition is above the first threshold, and the second visual feature replaces the initial visual feature when the condition is below the second threshold.

Clause 16: the processor is further configured to: detect whether the user has performed the activity; and if the user has performed the activity, operate the user sensor to detect an updated condition of the user and record, with the indicator, a comparison of the condition and the updated condition.

Clause 17: the processor is further configured to, after the user has performed the activity and when the condition of the user is below the threshold, operate the output device to provide the indicator based on the comparison of the condition and the updated condition.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A head-mountable device comprising:
an input device configured to receive a first input, a second input, and a third input;
an environment sensor configured to detect a feature of an environment;
an output device; and
a processor configured to operate the head-mountable device in a first mode in which:
the input device receives the first input; and
the environment sensor detects the feature of the environment while the input device receives the first input;
the processor being further configured to operate the head-mountable device in a second mode in which:
the input device receives the second input;
the output device outputs the first input and the feature of the environment from the first mode;
the input device receives the third input while the first input and the feature of the environment are being output; and
record the third input to be stored with the first input.

2. The head-mountable device of claim 1, wherein the input device comprises at least one of a microphone, a touch input device, an eye tracking device, a camera, or a force sensor.

3. The head-mountable device of claim 1, wherein the output device comprises at least one of a speaker, a display, or a haptic feedback device.

4. The head-mountable device of claim 1, wherein:
the environment sensor is a camera;
the output device is a display; and
the processor is configured to:
detect the feature of the environment by capturing an image of the environment with the camera; and
output the feature of the environment by outputting the image with the display.

5. The head-mountable device of claim 1, wherein:
the input device is a microphone;
the output device is a display;
the first input is speech; and
the processor is configured to output the first input on the display as text corresponding to the speech.

6. The head-mountable device of claim 1, further comprising an eye sensor configured to detect a condition of an eye, wherein the feature of the environment is detected by the environment sensor and output by the output device based on a detection of the eye sensor.

7. A head-mountable device comprising:
an input device configured to receive a first input and a second input;
a user sensor configured to detect a first condition and a second condition;
an output device; and
a processor configured to operate the head-mountable device in a first mode in which:
the input device receives the first input;
the processor records a feature of an event while the input device receives the first input; and
the user sensor detects a first condition while the input device receives the first input;
the processor being further configured to operate the head-mountable device in a second mode in which:
the input device receives the second input;
the output device outputs the first input;
the user sensor tracks a second condition while the input device receives the first input; and
the output device outputs the feature of the event based on a comparison between the first condition and the second condition.

8. The head-mountable device of claim 7, wherein the feature of the event comprises a feature from an environment.

9. The head-mountable device of claim 7, wherein the feature of the event comprises an output from the output device.

10. The head-mountable device of claim 7, wherein, in the second mode, the feature of the event is output until the second condition matches the first condition.

11. The head-mountable device of claim 7, wherein the user sensor is an eye tracking sensor, and the first condition and the second condition are conditions of an eye.

12. A head-mountable device comprising:
an output device;
a user sensor; and
a processor configured to:
operate the user sensor to detect a condition, the condition indicating an attention level with respect to an output of the output device; and
when the condition is below a threshold, operate the output device to provide an indicator to perform an activity until the condition exceeds the threshold.

13. The head-mountable device of claim 12, wherein the user sensor is an eye sensor, and the condition comprises at least one of pupil dilation, eyelid status, or blink rate.

14. The head-mountable device of claim 12, wherein the user sensor comprises at least one of a depth sensor, a touch sensor, a motion sensor, or a camera, and the condition comprises a feature of a face.

15. The head-mountable device of claim 12, wherein the condition comprises at least one of heart rate, respiration rate, or temperature.

16. The head-mountable device of claim 12, wherein the output device comprises a display, and the indicator comprises a visual feature output by the display when the condition is below the threshold.

17. The head-mountable device of claim 16, wherein:
the threshold is a first threshold;
the visual feature is a first visual feature; and
the indicator comprises a second visual feature, different than the first visual feature, output by the display when the condition is below a second threshold, different than the first threshold.

18. The head-mountable device of claim 17, wherein the display is configured to output an initial visual feature when the condition is above the first threshold, and the second visual feature replaces the initial visual feature when the condition is below the second threshold.

19. The head-mountable device of claim 12, wherein the processor is further configured to:
detect whether the activity has been performed; and
if the activity has been performed, operate the user sensor to detect an updated condition and record, with the indicator, a comparison of the condition and the updated condition.

20. The head-mountable device of claim 19, wherein the processor is further configured to, after the activity has been performed and when the condition is below the threshold, operate the output device to provide the indicator based on the comparison of the condition and the updated condition.
